(19) United States
(12) Patent Application Publication
(10) Pub. No.: US 2016/0006193 A1
(43) Pub. Date: Jan. 7, 2016

(54) CAR CHARGER ADAPTER

(71) Applicant: HUNG-CHANG LIU, New Taipei City (TW)

(72) Inventor: HUNG-CHANG LIU, New Taipei City (TW)

(21) Appl. No.: 14/322,222

(22) Filed: Jul. 2, 2014

(51) Int. Cl. H01R 24/58

(52) U.S. Cl. CPC H01R 24/58

(57) ABSTRACT

A car charger adapter includes a body, an electrode seat, at least one negative-electrode plate, a circuit assembly and a positive-electrode tip. The electrode seat and the circuit assembly is mounted inside the body. The at least one negative-electrode plate and the positive-electrode tip are respectively mounted on an outer periphery and a front end surface of the body. The at least one negative-electrode plate is bent to match a plane curvature of the outer periphery of the body, and is electrically connected to and securely mounted on the electrode seat and is electrically connected to the circuit assembly. The positive-electrode tip is electrically connected to the circuit assembly. When the car charger adapter is inserted in a cigarette lighter socket, the arc-shaped negative-electrode plate has larger contact area with an inner wall of the lighter socket, thereby lowering resistance of electrical contact and enhancing power utilization.

### BACKGROUND OF THE INVENTION

1. Field of the Invention

The present invention relates to a car charger adapter, and more particularly to a car charger adapter having two negative electrodes and large-area contact with an internal wall of a cigarette lighter socket after being inserted into the lighter socket.

2. Description of the Related Art

People get more attached to the use of power due to rising prevalence of digital electronic products. To meet the need of charging digital electronic products in long-distance driving, car charger adapters have been developed to be plugged in original cigarette lighter sockets of vehicles. With reference to FIG. 7, a conventional car charger adapter has a body 80, two negative-electrode spring plates 81, a positive-electrode tip 82 and an output cord 83. The body 80 is cylindrical and hollow and has two elongated openings 801 oppositely and axially formed through a periphery of the body 80. Each negative-electrode spring plate 81 is longer than the openings 801 and has a bulged portion and two side portions. The bulged portion is centrally formed on the negative-electrode spring plate 81 and is mounted through and protrudes outwards from one of the openings 801. The two side portions are blocked and fastened inside the body 80. The positive-electrode tip 82 is mounted through a front portion of the body 80. The output cord 83 is formed on a bottom portion of the body 80 and is electrically connected to the two negative-electrode spring plates 81 and the positive-electrode tip 82. With reference to FIG. 8, when the conventional car charger adapter is in use, the front portion of the body 80 is inserted into a cigarette lighter socket 90 such that the negative-electrode spring plates 81 abut against an inner wall of the body 80 through elastic forces of the negative-electrode spring plates 81 and the positive-electrode tip 82 is pushed to contact a deepest portion of the cigarette lighter socket 90 in completion of electrical connection with the positive and negative electrodes of the cigarette lighter socket 90. Power generated in the car is then outputted through the output cord 83 to charge a digital electronic product connected to the car charger adapter.

However, when the conventional car charger adapter is inserted into the cigarette lighter socket, plane curvatures of the bulged portions of the negative-electrode spring plates 81 and an inner wall of the cigarette light socket 90 may not fully match and point contact between the negative-electrode spring plates 81 and the inner wall of the cigarette light socket 90 is formed. As the contact area between the negative-electrode spring plates 81 and the cigarette light socket 90 becomes smaller, greater resistance of the electrical contact arises from the smaller electrical contact area and results in temperature rise of the car charger adapter and unnecessary power loss.

### SUMMARY OF THE INVENTION

An objective of the present invention is to provide a car charge adapter ensuring enhanced power utilization.

To achieve the foregoing objective, the car charger adapter has a body, an electrode seat, at least one negative-electrode plate, a circuit assembly and a positive-electrode tip.

The body has a front case and a rear case.

The front case has a through hole and an opening.

The through hole is formed through a front end of the front case.

The opening is formed through a rear end of the front case.

The rear case is connected with the front case and has two openings and multiple engagement walls.

The two openings are respectively formed through a front end and a rear end of the rear case.

The engagement walls are formed on, protrude frontwards from a front portion of the rear case, and are spaced apart from each other.

The electrode seat is mounted inside the body and has a ring and at least one resilient portion.

The at least one resilient portion is formed on an edge of the ring and is bent rearwards. Each one of the at least one resilient portion is located to correspond to a gap between adjacent two of the engagement walls and has an engagement hole formed through the resilient portion.

The at least one negative-electrode plate is mounted between the front case and the rear case. Each negative-electrode plate corresponds to the gap between the two corresponding arc-shaped engagement walls, has a plane curvature matching a plane curvature of a periphery of the rear case, is electrically connected to the electrode seat, and has a limiting block formed on an inner wall of the negative-electrode plate.

The circuit assembly is mounted inside the rear case and is electrically connected to the electrode seat.

The positive-electrode tip is mounted through the through hole of the front case and is electrically connected to the circuit assembly.

The advantage of the present invention resides in that when the car charger adapter is inserted into a cigarette lighter socket, the at least one negative-electrode plate mounted on the rear case has a plane curvature matching that of an outer periphery of the rear case and an inner wall of the cigarette lighter socket also has a plane curvature matching that of an outer periphery of the body such that a surface contact formed between the at least one negative-electrode plate and the inner wall of the cigarette lighter socket. Additionally, the at least one negative-electrode plate tightly contacts with the inner wall of the cigarette lighter socket as subjected to the elastic force of the at least one resilient portion of the electrode seat. Accordingly, the surface contact leads to larger contact area, a smaller resistance for electrical contact and a higher power utilization efficiency.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a car charger adapter in accordance with the present invention;

FIG. 2 is an exploded perspective view of the car charger adapter in FIG. 1;

FIG. 3 is an enlarged side view in partial section of the car charger adapter in FIG. 1;

FIG. 4 is another enlarged side view in partial section of the car charger adapter in FIG. 1;

FIG. 5 is a front view in partial section of the car charger adapter in FIG. 1;

FIG. 6 is an operational front view of the car charger adapter in FIG. 1;

FIG. 7 is a perspective view of a conventional car charger adapter; and

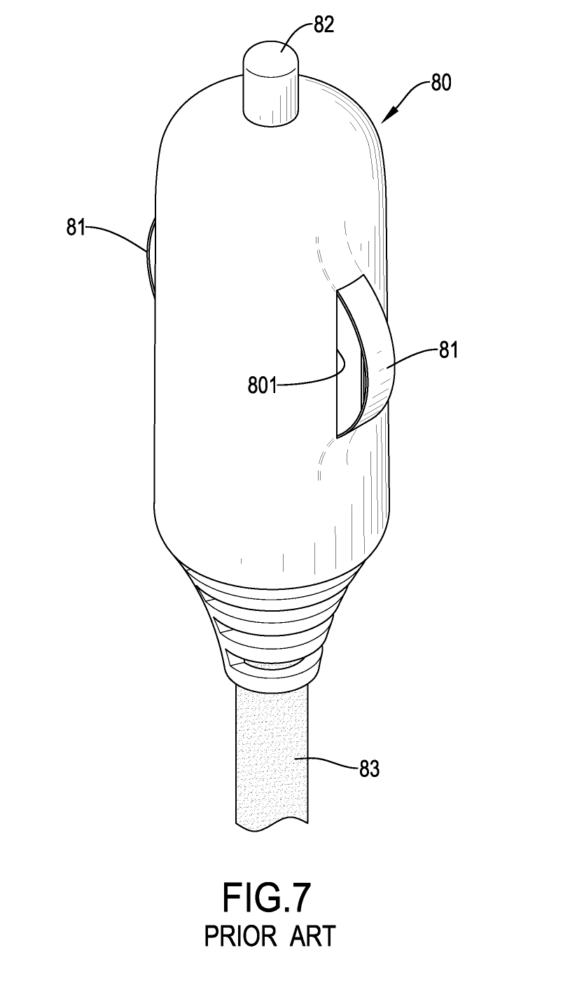

FIG. 8 is an operational front view of the conventional car charger adapter in FIG. 8.

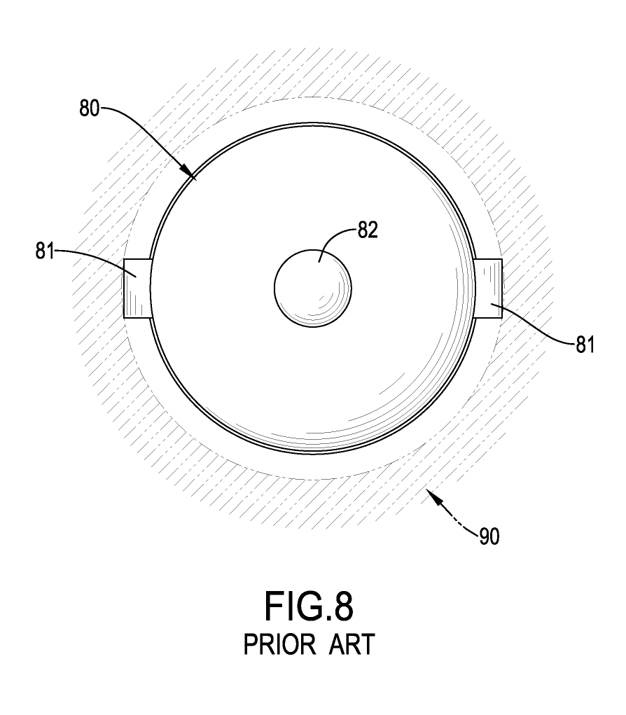

### DETAILED DESCRIPTION OF THE INVENTION

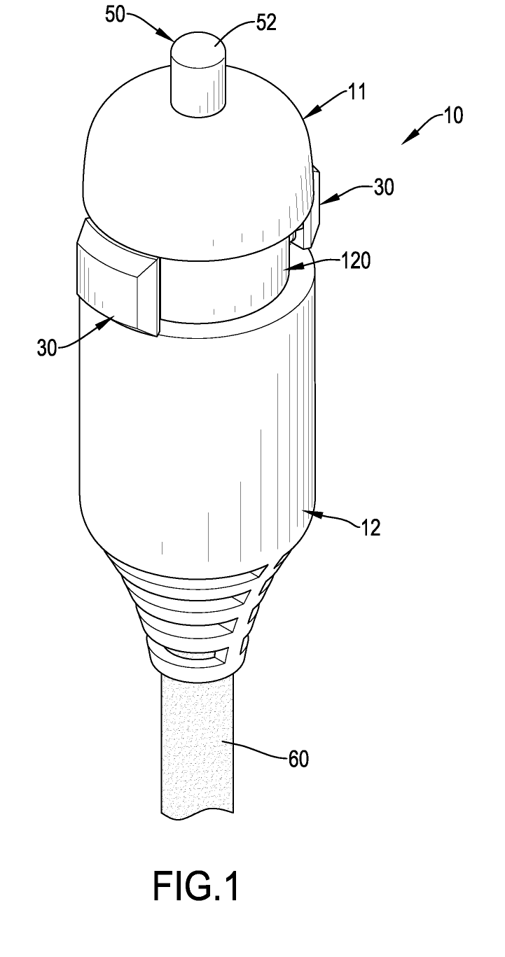

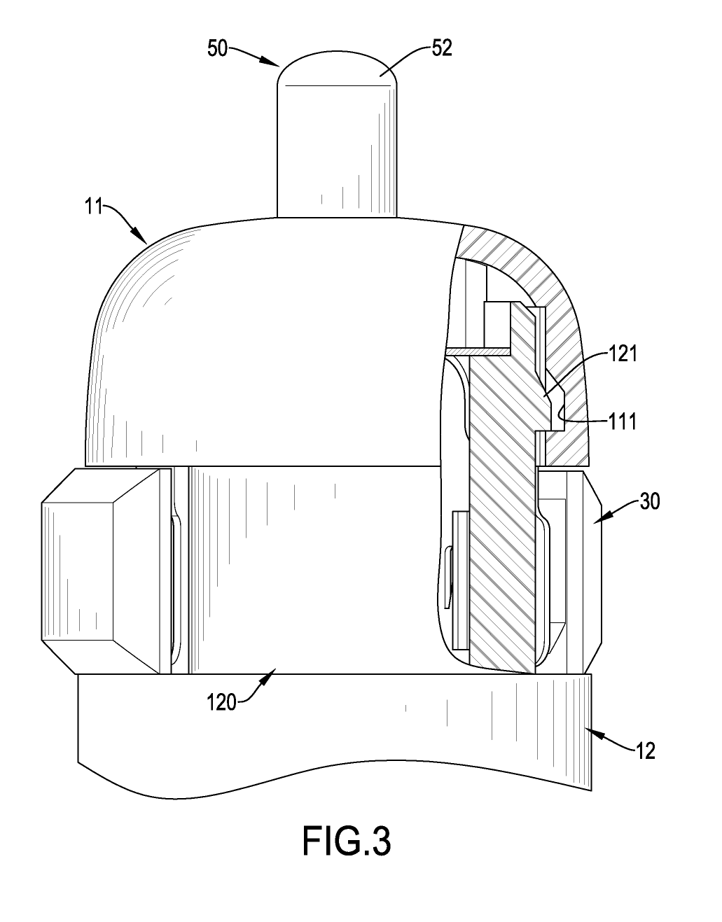

With reference to FIGS. 1 to 3, a car charger adapter in accordance with the present invention has a body 10, an electrode seat 20, at least one negative-electrode plate 30, a circuit assembly 40, a positive-electrode tip 50 and an output cord 60.

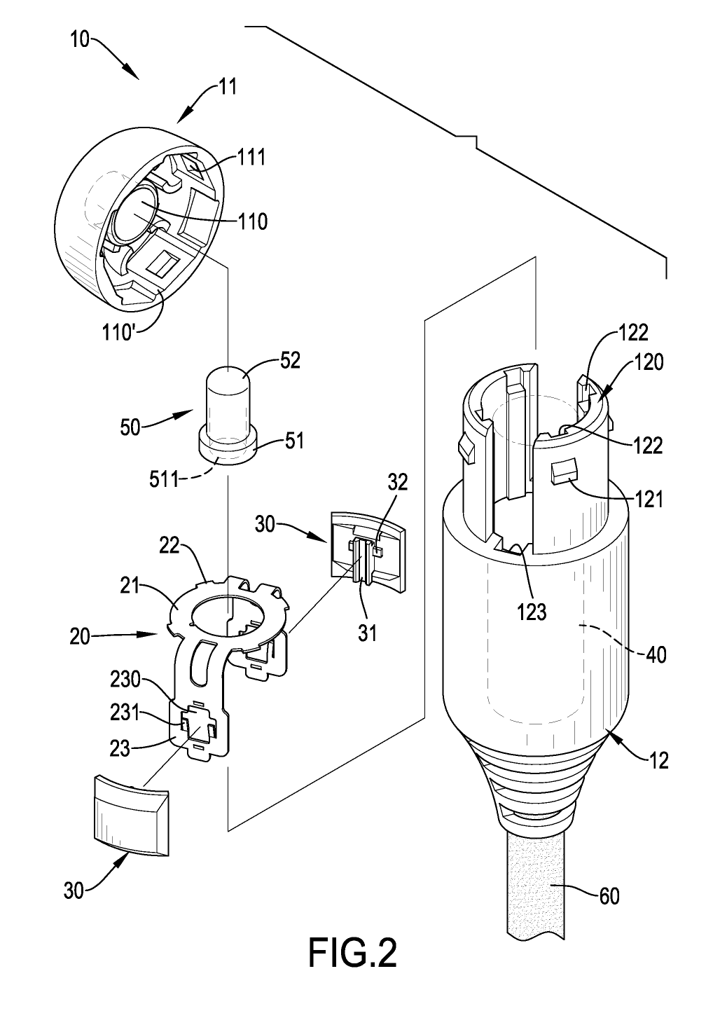

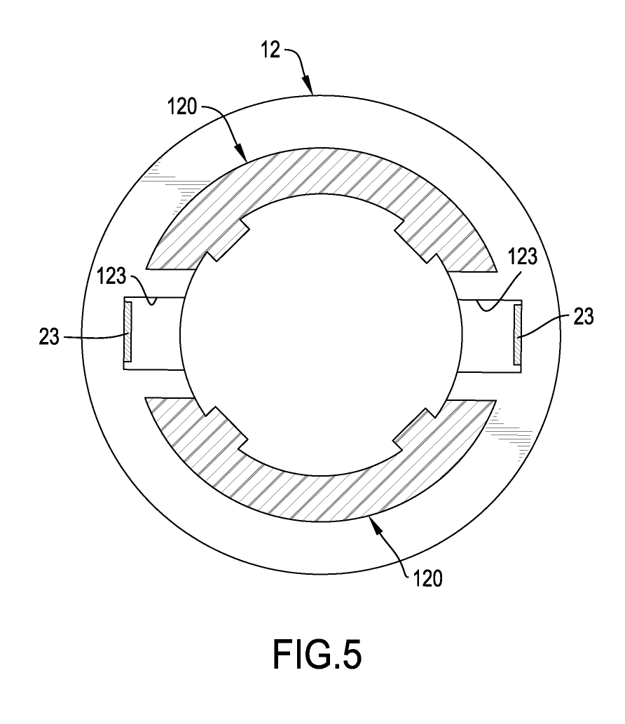

The body 10 is hollow and has a front case 11 and a rear case 12. The front case 11 has a through hole 110, an opening 110′ and multiple engagement recesses 111. The through hole 110 is formed through a front end of the front case 11. The opening 110′ is formed through a rear end of the front case 11. The engagement recesses 111 are radially formed in a portion of an inner wall of the front case 11 adjacent to the opening 110′ and are spaced apart. In the present embodiment, the front case 11 has four engagement recesses 111 spaced apart from each other by a gap. The rear case 12 has two openings and multiple engagement walls 120. The two openings are respectively formed through a front end and a rear end of the rear case 12. The engagement walls 120 are formed on and protrude frontwards from a perimeter of a front portion of the rear case 12, and are spaced apart from each other. In the present embodiment, the rear case 12 has two engagement walls 120 being arc-shaped, and each arc-shaped engagement wall 120 has two engagement blocks 121 formed on an outer periphery of the engagement wall 120 and respectively engaging the engagement recesses 111 of the front case 11. Each engagement wall further has multiple engagement slots 122 formed in an inner wall thereof In the present embodiment, each engagement wall 120 has two engagement slots 122. With reference to FIGS. 2 and 5, the rear case 12 further has at least one cavity 123, and each one of the at least one cavity 123 is formed in a portion of the rear case between adjacent two of the engagement walls 120 in a front-to-rear direction. In the present embodiment, the rear case 12 has two cavities 123.

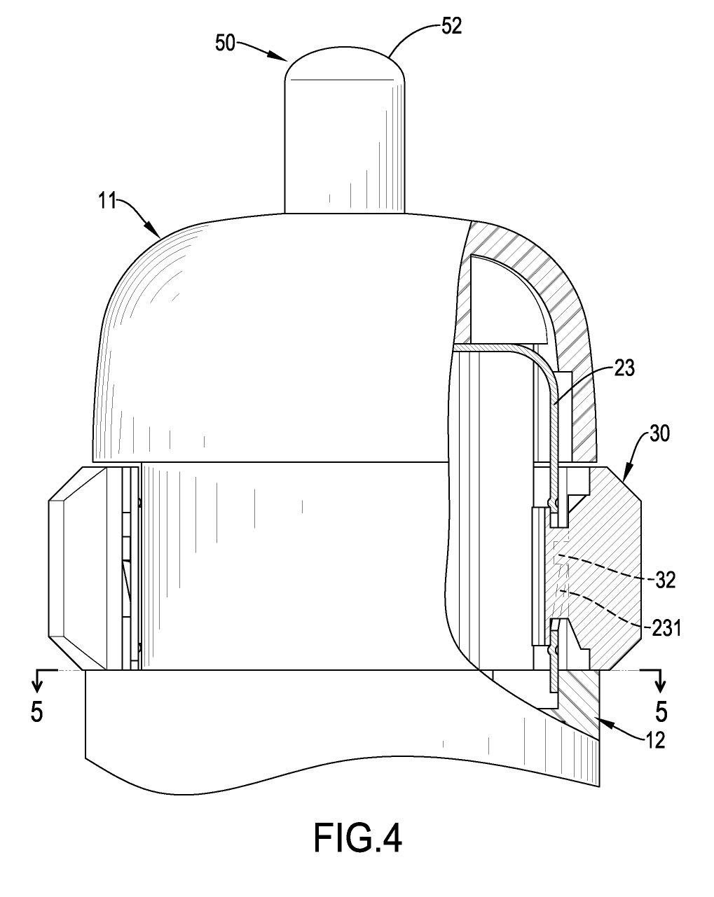

With reference to FIGS. 2, 4 and 5, the electrode seat 20 is held between the front case 11 and the rear case 12 and has a ring 21, multiple teeth 22 and at least one resilient portion 23. The teeth 22 are formed around and radially protrude outwards from an outer edge of the ring 21. In the present embodiment, the electrode seat 20 has four teeth 22, the ring 21 is received between the two arc-shaped engagement walls 120, and the four teeth 22 respectively correspond to the four engagement slots 122 of the two engagement walls 120. The at least one resilient portion 23 is formed on the edge of the ring 21 and is bent rearwards. In the present embodiment, the electrode seat 20 has two resilient portions 23, each resilient portion 23 is located to correspond to one of two gaps between the two arc-shaped engagement walls 120, and a rear end of the resilient portion 23 engages one of the cavities 123 of the rear case 12. With further reference to FIGS. 2 and 4, each one of the at least one resilient portion 23 has an engagement hole formed through the rear end thereof. In the present embodiment, the engagement hole is a cross-shaped engagement hole 230 and each resilient portion 23 has a spring leaf 231 formed on and protruding outwards from a rear edge of the engagement hole 230 of the resilient portion 23.

With further reference to FIGS. 1, 2 and 4, the at least one negative-electrode plate 30 includes two negative-electrode plates 30. The negative-electrode plates 30 are mounted inside the body 10 and are located between the front case 11 and the rear case 12, correspond to the respective gaps between the two arc-shaped engagement walls 120, have a plane curvature matching that of a periphery of the rear case 12, and are electrically connected to the electrode seat 20. With further reference to FIGS. 2 and 4, each negative-electrode plate 30 has a limiting block 31 and two bosses 32 formed on an inner wall of the negative-electrode plate 30. The limiting block 31 has a shorter portion and a longer portion divided by a position where the limiting block 131 is formed on the negative-electrode plate 30 with the shorter portion located above the longer portion and extending frontwards and the longer portion extending rearwards. The two bosses 32 are formed on an inner wall of the negative-electrode plate 30 and are respectively and symmetrically located on two opposite sides of the limiting block 31 in the front-to-rear direction. When the electrode seat 20 is assembled with the two negative-electrode plates 30, the limiting block 31 of each negative-electrode plate 30 is mounted through one of the engagement holes 230 of the electrode seat 20 and the bosses 32 respectively abut against rear surfaces of the spring leaves 231 of the electrode seat 20 such that the two negative-electrode plates 30 can be securely mounted on and electrically connected to the electrode seat 20.

The circuit assembly 40 is mounted inside the rear case 12 and is electrically connected to the electrode seat 20. The circuit assembly 40 may be a circuit board providing functions of regulating voltage and stabilizing current for converting power from the cigarette lighter socket into power suitable for charging any compatible digital electronic product.

The positive-electrode tip 50 is mounted through the through hole 110 of the front case 11, is electrically connected to the circuit assembly 40, and has a brim portion 51 and a cap portion 52. The brim portion 51 has an opening formed through the brim portion 51. The cap portion 52 is formed on and protrudes frontwards from a front side of the brim portion 51. An outer diameter of the cap portion 52 is smaller than a diameter of the through hole 110 of the front case 11 such that the cap portion 52 can be mounted through the through hole 110 in a rear-to-front direction. An outer diameter of the brim portion 51 is larger than the diameter of the through hole 110 such that the brim portion 51 is blocked and mounted inside the front case 11 without coming off the through hole 110.

The output cord 60 is securely connected to a rear end of the rear case 12 and is electrically connected to the circuit assembly 40.

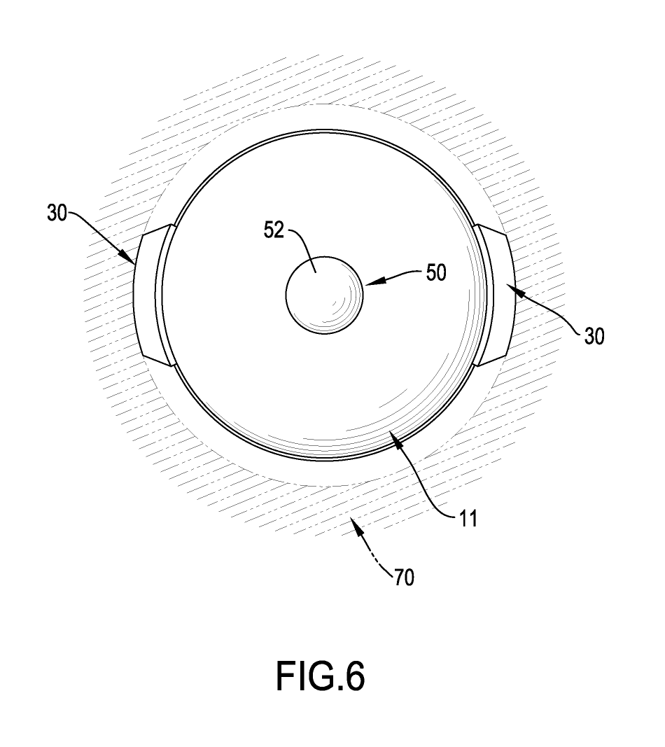

With reference to FIG. 6, when the car charger adapter is in use, a front portion of the body 10 of the car charger adapter is inserted into the cigarette lighter socket 70 of a vehicle such that the two negative-electrode plates 30 are pushed against an inner wall of the cigarette lighter socket 70 due to elastic force of the two resilient portions 23 of the electrode seat 20. After the body 10 is pushed to contact a deepest location of the cigarette lighter socket 70, electrical connection to positive and negative electrodes of the cigarette lighter socket is then completed and power from the cigarette lighter socket 70 is outputted to charge a compatible digital electronic product through the output cord 60.

In sum, the car charger adapter is advantageous in that the two negative-electrode plates 30 have a plane curvature matching with that of the outer periphery of rear case 12 when the front portion of the body 10 of the car charger adapter is inserted into the cigarette lighter socket 70. As the inner wall of the cigarette lighter socket 70 also has a plane curvature matching with that of the outer periphery of the body 10, the plane curvature of the negative-electrode plates 30 therefore matches that of the inner wall of the cigarette lighter socket 70 and the negative-electrode plates 30 form a surface contact with the inner wall of the cigarette lighter socket 70. The resilient portions 23 of the electrode seat 20 further push the respective negative-electrode plates 30 to abut against and closely contact with the inner wall of the cigarette lighter socket 70 for the negative-electrode plates 30 and the inner wall of the cigarette lighter socket 70 to form a surface contact, thereby significantly increasing the contact area, lowering the resistance of electrical contact, and enhancing power utilization.

Additionally, the number of the two negative-electrode plates 30 can be increased from two to four to provide more area in contact with the inner wall of the cigarette lighter socket and even better power utilization.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A car charger adapter, comprising:
a body having:
a front case having:
a through hole formed through a front end of the front case; and
an opening formed through a rear end of the front case;
a rear case connected with the front case and having:
two openings respectively formed through a front end and a rear end of the rear case; and
multiple engagement walls formed on, protruding frontwards from a front portion of the rear case, and spaced apart from each other;
an electrode seat mounted inside the body and having:
a ring; and
at least one resilient portion formed on an edge of the ring and bent rearwards, each one of the at least one resilient portion located to correspond to a gap between adjacent two of the engagement walls and having an engagement hole formed through the resilient portion;
at least one negative-electrode plate mounted between the front case and the rear case, each negative-electrode plate corresponding to the gap between the two corresponding engagement walls, having a plane curvature matching a plane curvature of a periphery of the rear case, electrically connected to the electrode seat, and having a limiting block formed on an inner wall of the negative-electrode plate;
a circuit assembly mounted inside the rear case and electrically connected to the electrode seat; and
a positive-electrode tip mounted through the through hole of the front case and electrically connected to the circuit assembly.

2. The car charger adapter as claimed in claim 1, wherein the electrode seat further has multiple teeth formed around and radially protruding outwards from an outer edge of the ring.

3. The car charger adapter as claimed in claim 2, wherein
the front case has multiple engagement recesses radially formed in a portion of an inner wall of the front case adjacent to the opening of the front case;
each engagement wall of the rear case has multiple engagement blocks formed on an outer periphery of the engagement wall and respectively engaging the corresponding engagement recesses of the front case; and
each engagement wall further has multiple engagement slots formed in an inner wall of the engagement wall and corresponding to the respective teeth on the ring of the electrode seat.

4. The car charger adapter as claimed in claim 1, wherein each one of the at least one resilient portion has a spring leaf formed on and protruding outwards from a rear edge of the engagement hole of the resilient portion.

5. The car charger adapter as claimed in claim 2, wherein each one of the at least one resilient portion has a spring leaf formed on and protruding outwards from a rear edge of the engagement hole of the resilient portion.

6. The car charger adapter as claimed in claim 3, wherein each one of the at least one resilient portion has a spring leaf formed on and protruding outwards from a rear edge of the engagement hole of the resilient portion.

7. The car charger adapter as claimed in claim 4, wherein each one of the at least one negative-electrode plate has two bosses formed on an inner wall of the negative-electrode plate, symmetrically located on two opposite sides of the limiting block in a front-to-rear direction, and abutting against one of the spring leaves of the electrode seat.

8. The car charger adapter as claimed in claim 5, wherein each one of the at least one negative-electrode plate has two bosses formed on an inner wall of the negative-electrode plate, symmetrically located on two opposite sides of the limiting block in a front-to-rear direction, and abutting against one of the spring leaves of the electrode seat.

9. The car charger adapter as claimed in claim 6, wherein each one of the at least one negative-electrode plate has two bosses formed on an inner wall of the negative-electrode plate, symmetrically located on two opposite sides of the limiting block in a front-to-rear direction, and abutting against one of the spring leaves of the electrode seat.

10. The car charger adapter as claimed in claim 7, wherein the positive-electrode tip has:
a brim portion having an opening formed through the brim portion; and
a cap portion formed on and protruding frontwards from a front side of the brim portion, wherein an outer diameter of the cap portion is smaller than a diameter of the through hole of the front case for the cap portion to be mounted through the through hole in a rear-to-front direction, and an outer diameter of the brim portion is larger than the diameter of the through hole for the brim portion to be blocked and mounted inside the front case.

11. The car charger adapter as claimed in claim 8, wherein the positive-electrode tip has:
a brim portion having an opening formed through the brim portion; and
a cap portion formed on and protruding frontwards from a front side of the brim portion, wherein an outer diameter of the cap portion is smaller than a diameter of the through hole of the front case for the cap portion to be mounted through the through hole in a rear-to-front direction, and an outer diameter of the brim portion is larger than the diameter of the through hole for the brim portion to be blocked and mounted inside the front case.

12. The car charger adapter as claimed in claim 9, wherein the positive-electrode tip has:
a brim portion having an opening formed through the brim portion; and
a cap portion formed on and protruding frontwards from a front side of the brim portion, wherein an outer diameter of the cap portion is smaller than a diameter of the through hole of the front case for the cap portion to be mounted through the through hole in a rear-to-front direction, and an outer diameter of the brim portion is larger than the diameter of the through hole for the brim portion to be blocked and mounted inside the front case.

13. The car charger adapter as claimed in claim 10, wherein the rear case further has at least one cavity, each one of the at least one cavity is formed in a portion of the rear case between adjacent two of the engagement walls in a front-to-rear direction, and a rear end of each one of the at least one resilient portion engages a corresponding cavity of the rear case.

14. The car charger adapter as claimed in claim 11, wherein the rear case further has at least one cavity, each one of the at least one cavity is formed in a portion of the rear case between adjacent two of the engagement walls in a front-to-rear direction, and a rear end of each one of the at least one resilient portion engages a corresponding cavity of the rear case.

15. The car charger adapter as claimed in claim 12, wherein the rear case further has at least one cavity, each one of the at least one cavity is formed in a portion of the rear case between adjacent two of the engagement walls in a front-to-rear direction, and a rear end of each one of the at least one resilient portion engages a corresponding cavity of the rear case.

16. The car charger adapter as claimed in claim 13, further comprising an output cord securely connected to a rear end of the rear case and electrically connected to the circuit assembly.

17. The car charger adapter as claimed in claim 14, further comprising an output cord securely connected to a rear end of the rear case and electrically connected to the circuit assembly.

18. The car charger adapter as claimed in claim 15, further comprising an output cord securely connected to a rear end of the rear case and electrically connected to the circuit assembly.
